(19) United States
(12) Patent Application Publication
(10) Pub. No.: US 2015/0114856 A1
(43) Pub. Date: Apr. 30, 2015

(54) COMBINATION POST-IT NOTE AND PAPER CLIP HOLDER

(71) Applicant: Steven Dornell Raymond, Houston, TX (US)

(72) Inventor: Steven Dornell Raymond, Houston, TX (US)

(21) Appl. No.: 14/066,882

(22) Filed: Oct. 30, 2013

(51) Int. Cl. B43M 99/00; A45C 11/00

(52) U.S. Cl. CPC B43M 99/009; A45C 11/00; B43M 99/008
USPC 206/214; 206/338

(57) ABSTRACT

A compact containment device that can efficiently combine several post-it notes and a paper clip holder. It is an object of the invention to provide convenient access to several flag notes and paper clips with various color options. The post-it note assembly and paper clip holder structure A and B. Can be manufactured from a rigid plastic, which provides a robust design that constitutes stability for the internal components and sturdy shielding from exterior environments.

The device also provides a simple and cost effective way of using both a paper clip holder and several post-it note assemblies. The portability and compact size allows the user to take the assembly to their desired location.

### RELATED APPLICATIONS

The present application is related to U.S. Pat. No. 636,269, issued Nov. 7, 1899, for COMBINED PAPER-CLIP AND PENCIL-HOLDER, by Sidney L. Long, included by reference herein.

The present application is related to U.S. Pat. No. 2,939,619, issued Jan. 22, 1958, for PAPER CLIP DISPENSER, by Roger Levesque, included by reference herein.

The present application is related to U.S. Pat. No. 3,911,533, issued Mar. 4, 1974, for PAPER CLIP HOLDER, by Welbourne D. McGahee, included by reference herein.

The present application is related to U.S. Pat. No. 4,530,445, issued Sep. 28, 1982, for PAPER CLIP HOLDER, by David E. Decker, included by reference herein.

The present application is related to U.S. Pat. No. 5,086,545, issued Dec. 27, 1990, for ONE-ACTION PAPER CLIP, by Takatoshi Suzuki, included by reference herein.

### FIELD OF THE INVENTION

The present invention relates to holding both post-it note assemblies and paper clips and, more particularly, to conveniently save space and efficiently create usability of both the post-it note assembly and paper clips within the home, office or student environment(s).

### BACKGROUND OF THE INVENTION

As humans we have been communicating to one another since the birth of mankind. Thus, to better translate, document, read and record information paper is used as one of the products. In order to, yet not limited to combine, organize, stack and differentiate paper, there are objects needed to help us perform the task, such as paper clips and/or post-it notes (flags).

Despite the advances in electronic technology and the virtue age, paper still remains to be a necessity to the functioning of business and society. The feel and texture of paper is still genuine and personal to most. Being able to place a tab on that special or important page is unique and gives us a since of ownership and connection to that source.

In lieu of having one or more post-it note assemblies loosely sitting on a desktop, chair, couch, table or any other location where it can easily be lost or misplaced, several of the assemblies can easily be loaded into the combination post-it note and paper clip holder where it is portable, saves space, organized and readily accessible. Hence, the post-it notes (flag) and/or paper clips can be used on page(s) in a book, file folder, loose paper, notebooks, pen holders, magazines, cups, clothing, office products and other objects.

The convenience of having a device that provides a space savings, portability, and a combination of functionality along with a reasonable price is ideal for the education, retail and office products industries. Currently the products are sold separately and are not complimentary for one another, which makes it more expensive for the consumers.

Whether it's for school, work, personal goal(s) or leisure, marking the significant page(s) or being able to clip papers or pages together provides a critical point of satisfaction for the end user. The convenience of having both a post-it note and a paper clip holder allows one to have a post-it note and a paper clip readily available is worth owning at a reasonable price.

There are other clips in the office supply industry, but none of the products provide a combination post-it note and paper clip holding device which allows for space savings, organizing, functionality and a convenient way of using a post-it note or paper clip. From the other perspective there are products that have post-it notes and paper clips on boards and or desk organizers, but again they do not offer the flexibility of being portable, a space saver, combined functionality and convenience. Desk organizers are designed to be stationary and remain on the desk.

### SUMMARY OF THE INVENTION

In accordance with the present invention, there is provided a compact containment device that can conveniently and efficiently combine several post-it notes and a paper clip holder. It is an object of the invention to provide convenient access to several flag notes and paper clips with various color options. The post-it note assembly and paper clip holder structure A and the post-it note assembly and paper clip holder structure B are the primary structures, which can be manufactured from a rigid plastic, which provides a robust design that constitutes stability for the internal components and sturdy shielding from exterior environments.

The post-it note assembly and paper clip holder structure A and the post-it note assembly and paper clip holder structure B provides a simple and cost effective way of using both a paper clip holder and several post-it note assemblies. The portability and compact size of the combination post-it note and paper clip assembly allows for the user to take the assembly anywhere and use the product at their convenience.

It would be advantageous to provide a design that is efficient, convenient, stable, sturdy, aesthetically diverse, portable and most importantly saves space and cost conservative for the end user.

It would also be advantageous to provide flexibility of pigmentation whereas both post-it note assembly and paper clip holder structure A and the post-it note assembly and paper clip holder structure B can be changed based on the user needs, such as black, red, blue, green, purple, yellow, etc. Or, it can be made to match the pigment of the room, furniture, office, school, library, coffee shop or any aesthetically desired environment by the end user.

It would further be advantageous to the various colors of the flags, which come or can be manufactured in black, red, blue, green, purple, yellow and several other pigmentations.

### BRIEF DESCRIPTION OF THE DRAWINGS

A complete understanding of the present invention may be obtained by reference to the accompanying drawings, when considered in conjunction with the subsequent, detailed description, in which:

FIG. 1 is an isometric (assembled and ready) view of a typical functioning position with one of the circular shaped openings for the post-it note assembly, which is angled towards the right direction within this patent, at the same time it shows the top portions of the fully assembled combination post-it note and paper clip holder in accordance with the invention;

FIG. 2 is an isometric (for clarity) view of a typical functioning position with one of the oval shaped openings for the post-it note assembly, which is angled towards the right direction within this patent, at the same time it shows the top portions of the fully assembled combination post-it note and paper clip holder in accordance with the invention;

FIG. 3 is a side (right) view of a functional and fully assembled combination post-it note and paper clip holder that is positioned with one of the circular shaped openings for the post-it note assembly facing the right side and no other sides are shown, which is in accordance with the invention;

FIG. 4 is a front (no hidden lines) view of a functional and fully assembled combination post-it note and paper clip holder that is positioned with one of the oval shaped openings for the post-it note assembly facing the front plane and no other sides are shown, which is in accordance with the invention;

FIG. 5 is a rear (no hidden lines) view of a functional and fully assembled combination post-it note and paper clip holder that is positioned with one of the oval shaped openings for two post-it note assemblies facing the rear plane and no other sides are shown, which is in accordance with the invention;

FIG. 6 is a top (no hidden lines) view of a functional and fully assembled combination post-it note and paper clip holder that is positioned as if the end user is looking from the top plane, which displays all of the post-it note assemblies inserted within the cavities of the primary structure, moreover the outline of the primary structure is clearly identifiable and no other sides are shown, which is in accordance with the invention;

FIG. 7 is a bottom (no hidden lines) view of a functional and fully assembled combination post-it note and paper clip holder that is positioned as if the end user is looking from the bottom plane, which displays only the flags of the post-it note assemblies, the bottom of the paper clip holder is shown along with the outline of the primary structure and no other sides are shown, which is in accordance with the invention;

FIG. 8 is a vertical section cut view of a functional and fully assembled combination post-it note and paper clip holder that is in the position for use which is vertically arranged and the section cut is through the center of the entire assembly, which displays the internal as well as external components of this patent and no other sides are shown, which is in accordance with the invention;

FIG. 9 is a horizontal section cut view of a functional and fully assembled combination post-it note and paper clip holder that is positioned as if the end user is looking from the top plane, in addition to cutting horizontally through the middle of the entire assembly, which displays the internal as well as the external components of this patent. this view further displays all of the post-it note assemblies inserted within the cavities of the primary structure, conjointly the outline of the primary structure is clearly identifiable and no other sides are shown, which is in accordance with the invention;

FIG. 10 is an isometric exploded view of a dismantled assembly which is tilted at an angle to abet in the clarification of the claims within this patent and a determination of identification can be conducted while in the fully disassembled position of the combination post-it note and paper clip holder in accordance with the invention;

FIG. 11 is an isometric exploded (for clarity) view of a dismantled assembly which is tilted at an angle to abet in the clarification of the claims within this patent and a determination of identification can be conducted while in the fully disassembled position of the combination post-it note and paper clip holder in accordance with the invention;

FIG. 12 is an isometric exploded (rear) view of a dismantled assembly which is facing the rear plane at the same time vertically arranged to abet in the clarification of the claims within this patent and a determination of identification can be conducted while in the fully disassembled position of the combination post-it note and paper clip holder in accordance with the invention;

FIG. 13 is a vertical section cut (alternative design) view of a functional and fully assembled combination post-it note and paper clip holder that is in the position for use; which is vertically arranged and the section cut is through the center of the entire assembly, which displays the internal and external alternative components in addition to the claims of this patent moreover no other sides are shown, which is in accordance with the invention;

FIG. 14 is an isometric exploded (alternative design) view of a dismantled assembly which is tilted at an angle to abet in the clarification of the alternative claims within this patent and a determination of identification can be conducted while in the fully disassembled position of the combination post-it note and paper clip holder in accordance with the invention; and

FIG. 15 is an isometric exploded (clarity of alternative design) view of a dismantled assembly which is facing the rear plane at the same time vertically arranged to abet in the clarification of the alternative claims within this patent and a determination of identification can be conducted while in the fully disassembled position of the combination post-it note and paper clip holder in accordance with the invention.

For purposes of clarity and brevity, like elements and components will bear the same designations and numbering throughout the Figures.

### DESCRIPTION OF THE PREFERRED EMBODIMENT

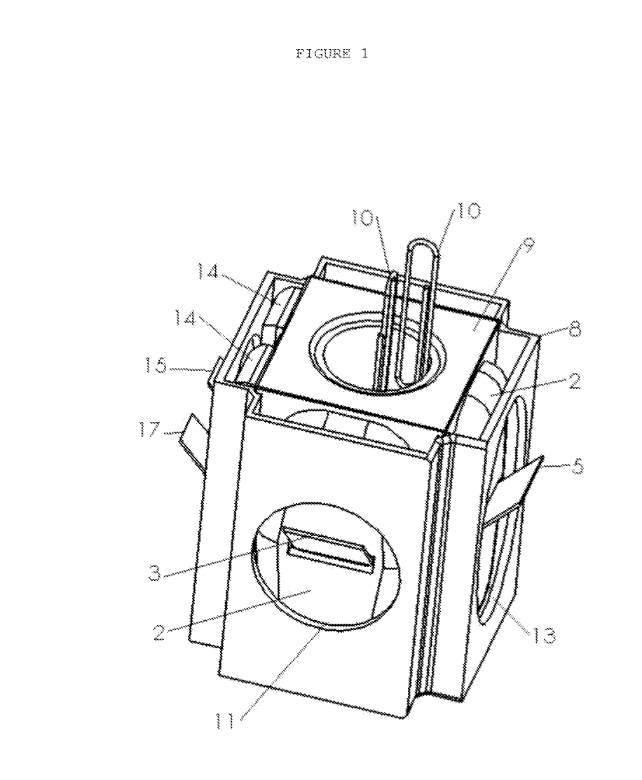

FIG. 1 is an isometric (assembled and ready) view of a typical functioning position with one of the circular shaped openings for the post-it note assembly, which is angled towards the right direction within this patent, at the same time it shows the top portions of the fully assembled combination post-it note and paper clip holder 21 in accordance with the invention.

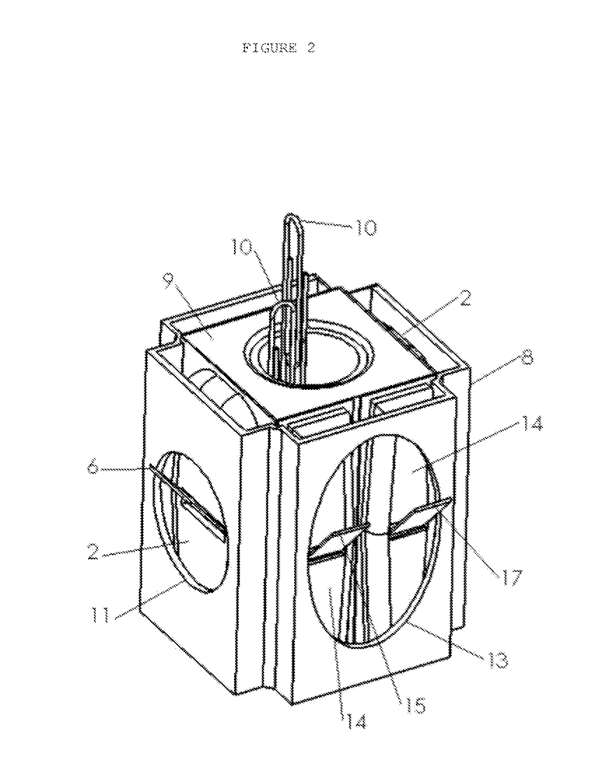

FIG. 2 is an isometric (for clarity) view of a typical functioning position with one of the oval shaped openings for the post-it note assembly, which is angled towards the right direction within this patent, at the same time it shows the top portions of the fully assembled combination post-it note and paper clip holder 21 in accordance with the invention.

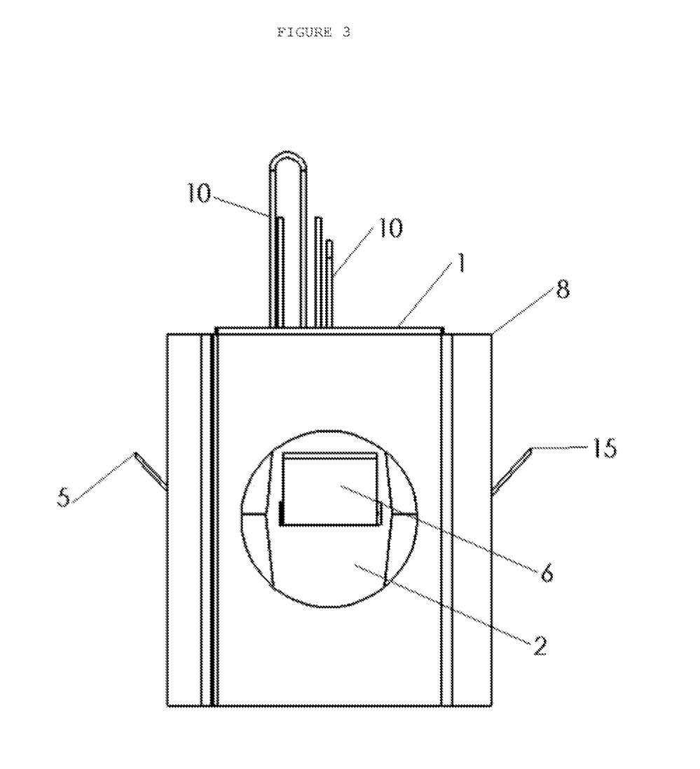

FIG. 3 is a side (right) view of a functional and fully assembled combination post-it note and paper clip holder 21 that is positioned with one of the circular shaped openings for the post-it note assembly facing the right side and no other sides are shown, which is in accordance with the invention.

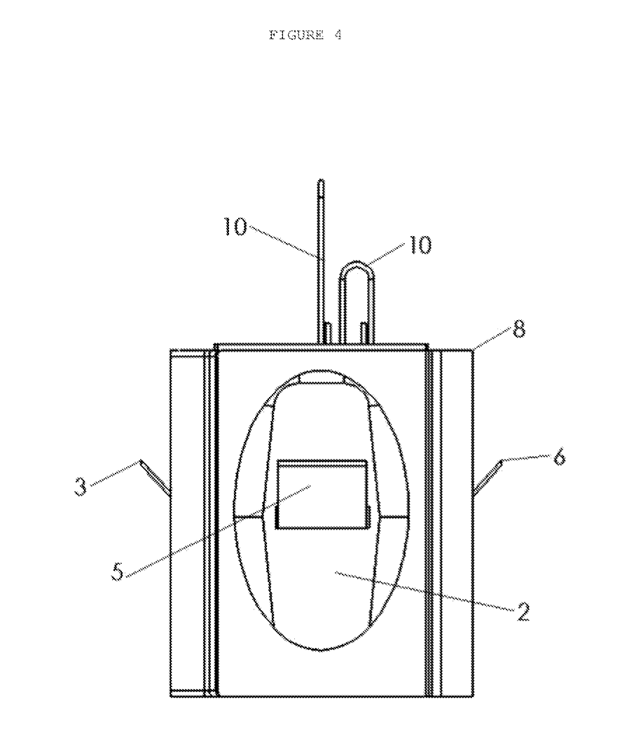

FIG. 4 is a front (no hidden lines) view of a functional and fully assembled combination post-it note and paper clip holder 21 that is positioned with one of the oval shaped openings for the post-it note assembly facing the front plane and no other sides are shown, which is in accordance with the invention.

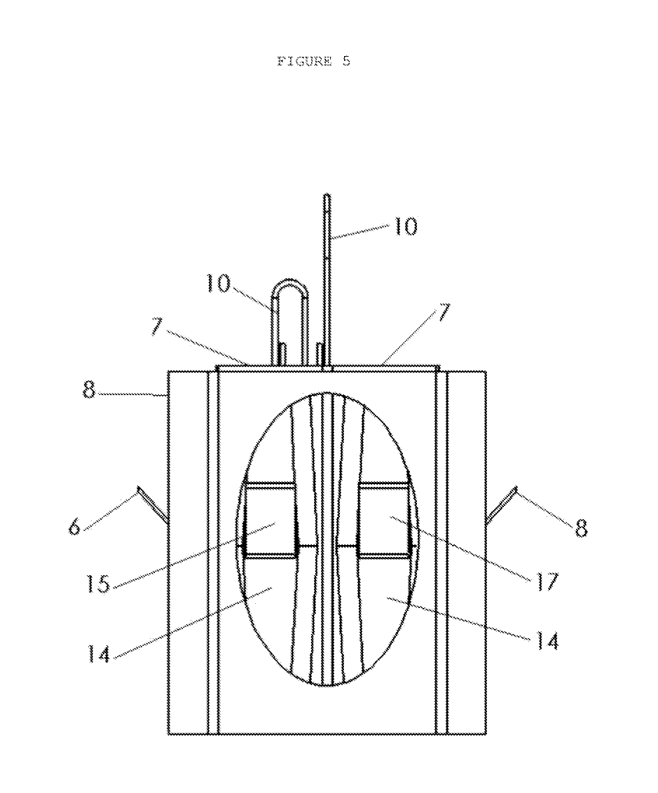

FIG. 5 is a rear (no hidden lines) view of a functional and fully assembled combination post-it note and paper clip holder 21 that is positioned with one of the oval shaped openings for two post-it note assemblies facing the rear plane and no other sides are shown, which is in accordance with the invention.

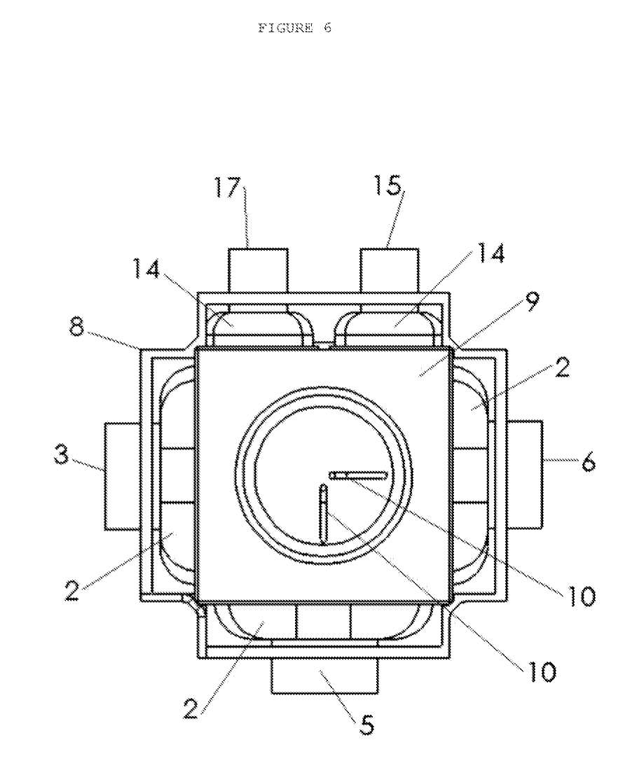

FIG. 6 is a top (no hidden lines) view of a functional and fully assembled combination post-it note and paper clip holder 21 that is positioned as if the end user is looking from the top plane, which displays all of the post-it note assemblies inserted within the cavities of the primary structure, moreover the outline of the primary structure is clearly identifiable and no other sides are shown, which is in accordance with the invention.

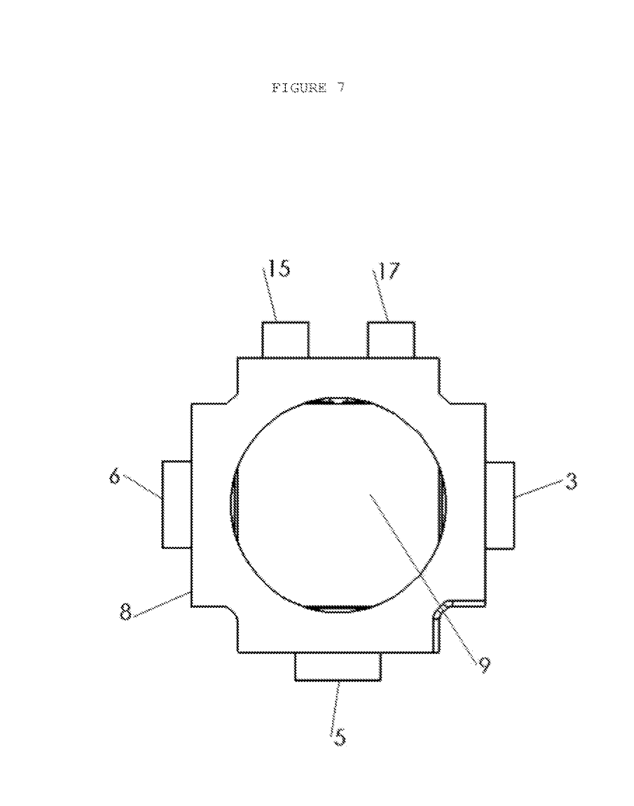

FIG. 7 is a bottom (no hidden lines) view of a functional and fully assembled combination post-it note and paper clip holder 21 that is positioned as if the end user is looking from the bottom plane, which displays only the flags of the post-it note assemblies, the bottom of the paper clip holder 9 is shown along with the outline of the primary structure and no other sides are shown, which is in accordance with the invention.

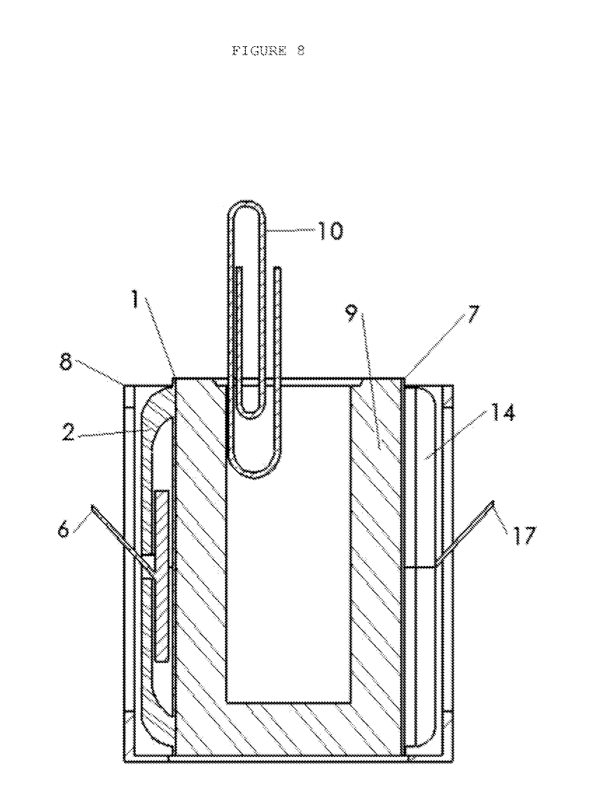

FIG. 8 is a vertical section cut view of a functional and fully assembled combination post-it note and paper clip holder 21 that is in the position for use which is vertically arranged and the section cut is through the center of the entire assembly, which displays the internal as well as external components of this patent and no other sides are shown, which is in accordance with the invention.

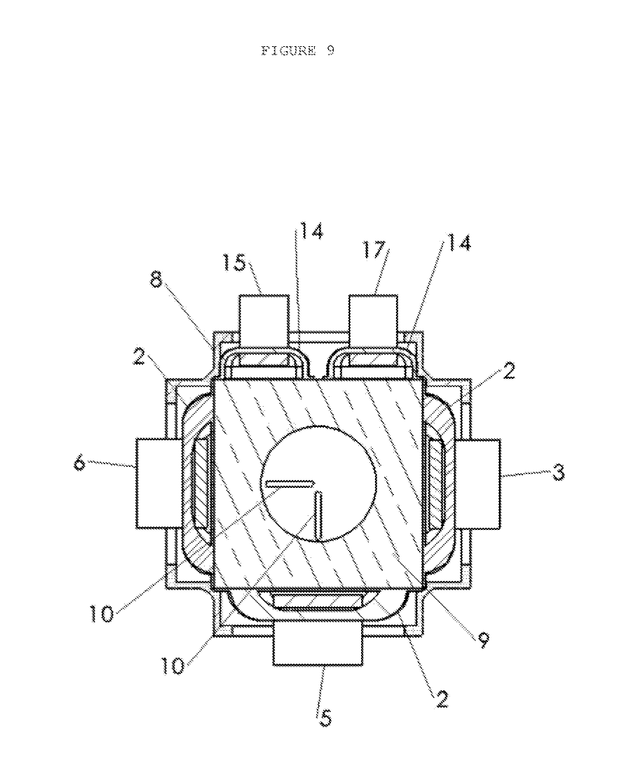

FIG. 9 is a horizontal section cut view of a functional and fully assembled combination post-it note and paper clip holder 21 that is positioned as if the end user is looking from the top plane, in addition to cutting horizontally through the middle of the entire assembly, which displays the internal as well as the external components of this patent. This view further displays all of the post-it note assemblies inserted within the cavities of the primary structure, conjointly the outline of the primary structure is clearly identifiable and no other sides are shown, which is in accordance with the invention.

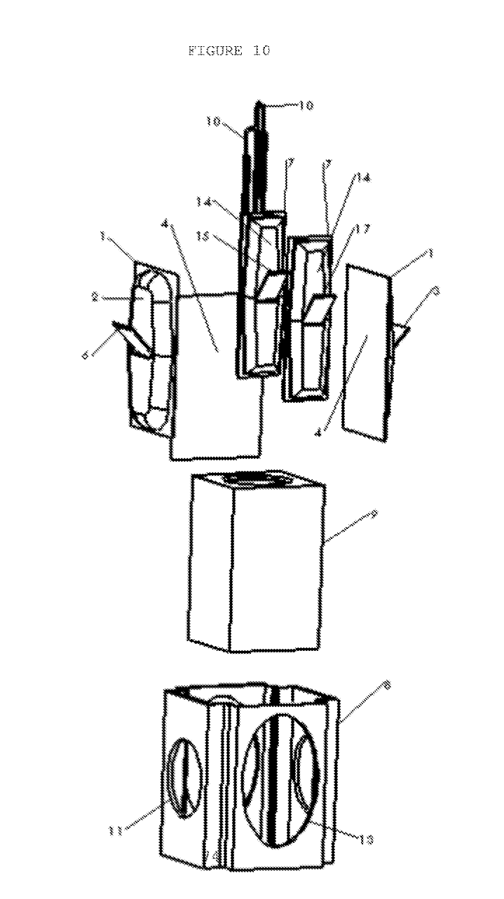

FIG. 10 is an isometric exploded view of a dismantled assembly which is tilted at an angle to abet in the clarification of the claims within this patent and a determination of identification can be conducted while in the fully disassembled position of the combination post-it note and paper clip holder 21 in accordance with the invention.

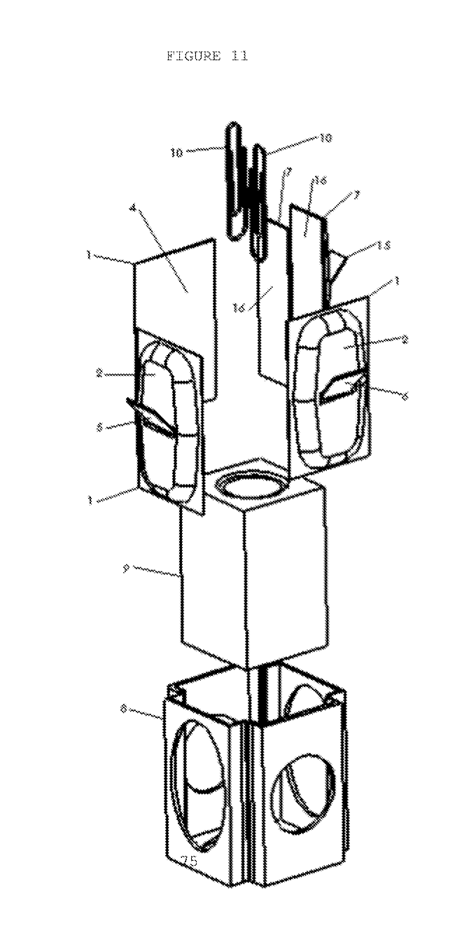

FIG. 11 is an isometric exploded (for clarity) view of a dismantled assembly which is tilted at an angle to abet in the clarification of the claims within this patent and a determination of identification can be conducted while in the fully disassembled position of the combination post-it note and paper clip holder 21 in accordance with the invention.

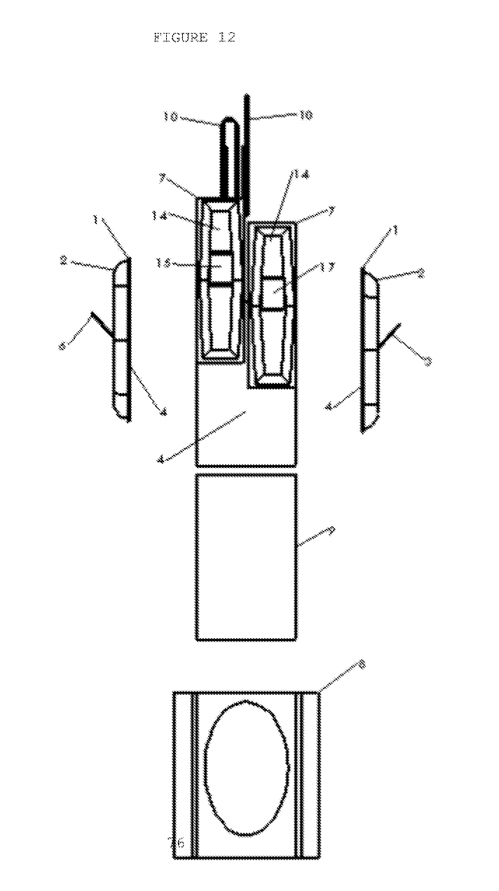

FIG. 12 is an isometric exploded (rear) view of a dismantled assembly which is facing the rear plane at the same time vertically arranged to abet in the clarification of the claims within this patent and a determination of identification can be conducted while in the fully disassembled position of the combination post-it note and paper clip holder 21 in accordance with the invention.

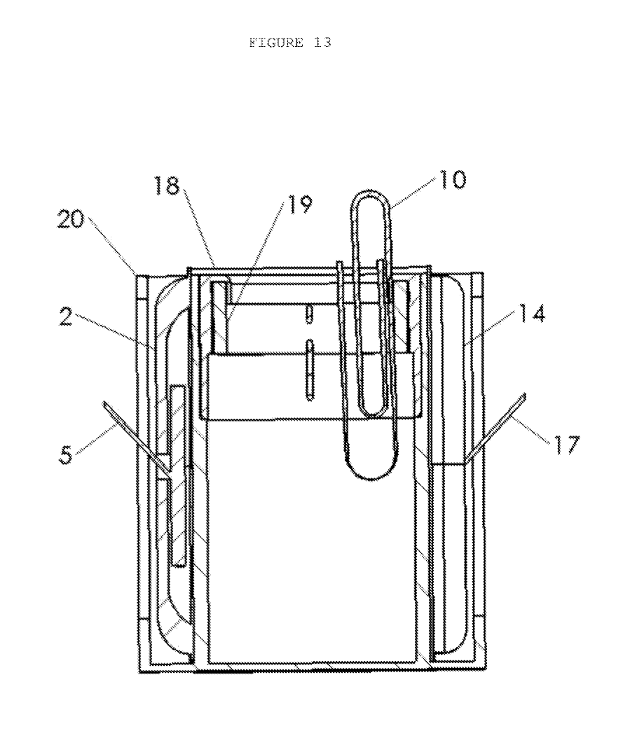

FIG. 13 is a vertical section cut (alternative design) view of a functional and fully assembled combination post-it note and paper clip holder 21 that is in the position for use; which is vertically arranged and the section cut is through the center of the entire assembly, which displays the internal and external alternative components in addition to the claims of this patent moreover no other sides are shown, which is in accordance with the invention.

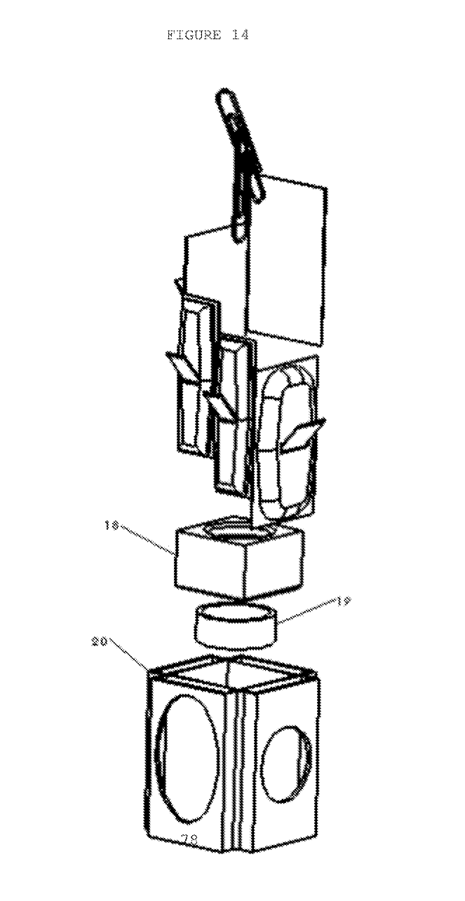

FIG. 14 is an isometric exploded (alternative design) view of a dismantled assembly which is tilted at an angle to abet in the clarification of the alternative claims within this patent and a determination of identification can be conducted while in the fully disassembled position of the combination post-it note and paper clip holder 21 in accordance with the invention.

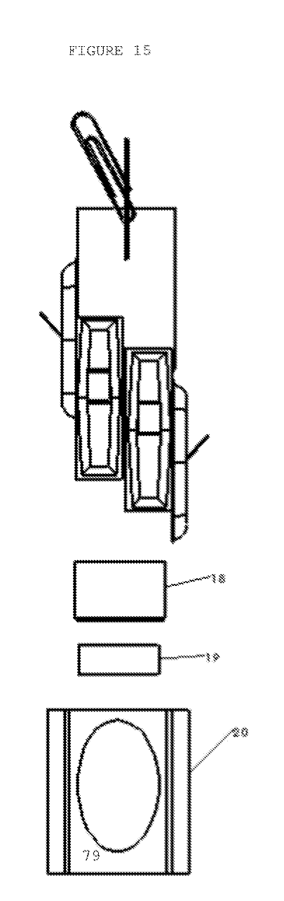

FIG. 15 is an isometric exploded (clarity of alternative design) view of a dismantled assembly which is facing the rear plane at the same time vertically arranged to abet in the clarification of the alternative claims within this patent and a determination of identification can be conducted while in the fully disassembled position of the combination post-it note and paper clip holder 21 in accordance with the invention.

The primary assemblies of this patent are comprised of all of the secondary assemblies and components mated, connected and inserted into a final apparatus for use, for instance, FIGS. 1, 2, 8 and 13.

The secondary assemblies are the post-it note assembly (A) 1 and post-it note assembly (B) 7, which are the completely derived assemblies from the detail components: top structure A 2 2, flag set (A) 3 and the bottom structure (A) 4; top structure A 2 2, flag set (B) 5, bottom structure (A) 4; top structure A 2 2, flag set (C) 6, bottom structure (A) 4; top structure (B) 14, flag set (D) 15, bottom structure (B) 16; top structure (B) 14, flag set (E) 17, bottom structure (B) 16.

Furthermore, with the post-it note assembly being a completely derived assembly from three detail components: top structure, the flag set and the bottom structure, are manufactured at 3M Office Supply Division, St. Paul, Minn. The colored flag set (A) 3, flag set (B) 5, flag set (C) 6, flag set (D) 15, and flag set (E) 17 vary from green, blue, yellow, purple and other common or uncommon pigmentations. Each flag set (A) 3, flag set (B) 5, flag set (C) 6, flag set (D) 15, and flag set (E) 17 is comprised of a plurality of rectangular polymer based flat sheets or flag with an adhesive bonding agent applied to only one side of a two sided sheet or flag.

As per FIG. 1, the assembly is positioned vertically and represents the fully assembled isometric view with a circular opening 11 in the post-it note assembly and paper clip holder structure (A) 8 slightly facing the right direction as well as tilted downward.

FIG. 2 is an assembly which is positioned vertically and represents the fully assembled isometric view with both a circular opening 11 and oval opening 13 in the post-it note assembly and paper clip holder 9 structure A 8 slightly facing the right and left directions respectively as well as tilted downward. FIGS. 1 and 2, display the top of the paper clip holder 9 with the paper clip 10 extending beyond the top plane. In addition, portions of the: post-it note assembly (A) 1, post-it note assembly (B) 7, top structure A 2 2, top structure (B) 14, flag set (A) 3, flag set (B) 5, flag set (E) 17 and paper clip holder 9 are shown as if the components have been assembled and the apparatus is ready for use.

FIG. 3 right side view is positioned vertically in a ready for use state. The circular opening 11 is shown on the right side, with the post-it note assembly (A) 1 inserted into the rectangular cavities of the post-it note assembly and paper clip holder 9 structure A 8. The flag set (C) 6 is protruding into the right plane while flag set (B) 5 is protruding in the left outward direction and flag set (D) 15 is protruding in the right outward direction.

FIG. 4 front view is positioned vertically in a ready for use state. The oval opening 13 is shown on the front plane, with the post-it note assembly (A) 1 inserted into the rectangular cavities of the post-it note assembly and paper clip holder 9 structure A 8. The flag set (B) 5 is protruding into the front plane while flag set (A) 3 is protruding in the left outward direction and flag set (C) 6 is protruding in the right outward direction.

FIGS. 3, 4, 5, 6 and 8 illustrates that the post-it note assembly (A) 1 is being stabilized by the friction and compression forces between the outer surface of the top structure A 2 and the interior surface within the cavity of the post-it not assembly and paper clip holder 9 structure A 8, as well as forces between the outer surface of the bottom structure (A) 4 and the exterior surface of the paper clip holder 9. The top structure A 2 is manufactured from a polymer base material which is thin and molded at the same time flexible enough to absorb the compression forces from the inner surface cavities of the post-it note assembly and paper clip holder 9 structure A 8. There are friction forces applied between the two longest vertical edges of both bottom structure (A) 4 as well as bottom structure (B) 16 and the inner most edges of the cavities in the post-it note assembly and paper clip holder 9 structure A 8.

FIGS. 1, 2, 3, 4, 5, and 8 illustrates the iron base metallic paper clip 10 being extended beyond the top plane of the post-it note assembly and paper clip holder 9 structure A 8. The paper clip 10 is magnetically attached to the magnet 19 which is ensconced within the upper most housing of the rigid structure that's part of the paper clip holder 9. The outer coating of the paper clip 10 is polished chrome, which protects the iron base material from corroding. The paper clip holder 9 is capable of retaining various sizes and shapes of paper clips.

FIG. 7 exhibits a fully assembled apparatus from the bottom view. The post-it note assembly and paper clip holder 9 structure A 8 has a circular hole in the bottom or base of the structure to save on the use of excess plastic material, in addition to reducing the weight of the apparatus in turn increasing the value of being portable. Next, the bottom of the paper clip holder 9 is easily delineated from the post-it note assembly and paper clip holder 9 structure A 8, by covering the circular hole. Lastly, flag set (A) 3, flag set (B) 5, flag set (C) 6, flag set (D) 15 and flag set (E) 17, extend through and beyond the outer plane of the circular opening 11 and oval opening 13 of the post-it note assembly and paper clip holder 9 structure A 8.

FIG. 8, depicts a functional and fully amassed combination post-it note and paper clip holder 21 which is positioned vertically and the vertical section cut is through the center of the entire assembly, which displays the internal as well as external components. Moreover, a representation of the thickness of each component; flag set (C) 6, flag set (E) 17, paper clip 10, post-it note assembly (A) 1, post-it note assembly (B) 7, paper clip holder 9, top structure A 2 2, top structure (B) 14 and post-it note assembly and paper clip holder 9 structure A 8, can be delineated for but not limited to manufacturing, assembly, and presentation purposes. The contact surfaces are distinguishable by the delineated lines and hatched segments, such as, the friction between the outer surface of the bottom structure (A) 4 amongst the post-it note assembly (A) 1, which is manufactured from a cardboard type material and the outer surface of the paper clip holder 9 derived from a polymer based material, respectively. The second example is the contact surfaces between the outer surface of the bottom structure (B) 16 amongst the post-it note assembly (B) 7 which is manufactured from a cardboard type material and the outer surface of the paper clip holder 9 which is derived from a polymer based material. Per the two previous examples the cardboard and the polymer materials for the outer surfaces of the bottom structure (A) 4, bottom structure (B) 16, and the paper clip holder 9 have smooth textures, thus the interference fit tolerance and compression forces provide an ensconce fit into the post-it note assembly and paper clip holder 9 structure A 8. Another distinguishable contact surface is the vertical plurality between the adhesive based bottom surface of flag set (C) 6 and the inner surface of the bottom structure (A) 4.

FIG. 9, depicts a functional and fully amassed combination post-it note and paper clip holder 21 which is being viewed from the top plane and the horizontal section cut is through the center of the entire assembly, which displays the internal as well as external components from the top prospective. The contact surfaces are distinguishable by the delineated lines and hatched segments, such as, the friction between the four inner 90 degree corner surfaces of the post-it note assembly and paper clip holder 9 structure A 8 and the four outer 90 degree corner surfaces of the paper clip holder 9, whereas both are manufactured from a polymer based material. The interference fit tolerance and friction forces provides stability in all directions, as well as an ensconce fit between the paper clip holder 9 and the post-it note assembly and paper clip holder 9 structure A 8. Moreover, a representation of the thickness of each component; flag set (C) 6, flag set (E) 17, paper clip 10, post-it note assembly (A) 1, post-it note assembly (B) 7, paper clip holder 9, top structure A 2, top structure (B) 14 and post-it note assembly and paper clip holder 9 structure A 8, can be delineated for but not limited to manufacturing, assembly, and presentation purposes.

FIGS. 10, 11 and 12, are dismantled versions of the full assembly that depicts the isometric and rear exploded views which typifies clarity, and is positioned vertically where each detailed part or assembly is identifiable. The flat rectangular outer surface of both bottom structure (A) 4 and bottom structure (B) 16 are macroscopic. The assemblies and detail parts are identified from top to bottom as; paper clip 10, post-it note assembly (B) 7, post-it note assembly (A) 1, paper clip holder 9 and post-it note assembly and paper clip holder 9 structure A 8.

The primary structure of the combination post-it note and paper clip holder 21 is the post-it note assembly and paper clip holder 9 structure A 8, which can be manufactured from the following materials but not limited to, a rigid thermoplastic or thermoset polymer, by which plastic injection molding machine, casting dies as well as tooling equipment would be required for production. With this method an assortment of colors are electable, such as black, red, green, blue, purple and as requested from the populous. With the plastic injection molding method all of the contours, holes, openings and other ambiguous features can be formed in one manufacturing process step. The polymer would have less density which aids in portability, imperceptible number of manufacturing process steps in comparison to a metallic or ceramic material of the plural design. Post-it note assembly and paper clip holder 9 structure A 8, regardless of the material, the wall structure is solid from the interior surface to exterior surface, thus providing stability for the components that will be encapsulated within the structure and surface texture.

The most massive component within the entire combination post-it note and paper clip holder 21 assembly is the paper clip holder 9, fabricated from a polymer based material. The second most massive component is the post-it note assembly and paper clip holder 9 structure A 8. Then the mass tapers down from the post-it note assembly (A) 1, to post-it note assembly (B) 7, and finally the paper clip 10.

In FIG. 13, there are friction forces applied between the two longest vertical edges of both bottom structure (A) 4 as well as bottom structure (B) 16 and the inner most edges of the cavities in the post-it note assembly and paper clip holder structure (B) 20.

In more detail, FIG. 13 depicts a functional and fully amassed combination post-it note and paper clip holder 21 which is positioned vertically and the vertical section cut is through the center of the entire assembly, which displays the internal as well as external components. Thus, a representation of the thickness of each component; flag set (B) 5, flag set (E) 17, paper clip 10, post-it note assembly (A) 1, post-it note assembly (B) 7, cap structure 18, magnet 19, top structure A 2, top structure (B) 14 and post-it note assembly and paper clip holder structure (B) 20, can be delineated for but not limited to manufacturing, assembly, and presentation purposes. The contact surfaces are distinguishable by the delineated lines and hatched segments, such as, the friction between the outer surface of the bottom structure (A) 4 amongst the post-it note assembly (A) 1, which is manufactured from a cardboard type material and the inner surface of the cavity with the post-it note assembly and paper clip holder structure (B) 20 which is derived from a polymer based material. The second example is the contact surfaces between the outer surface of the bottom structure (B) 16 amongst the post-it note assembly (B) 7 which is manufactured from a cardboard type material and the inner surface of the cavity with the post-it note assembly and paper clip holder structure (B) 20 which is derived from a polymer based material. Per the two previous examples the cardboard and the polymer materials for the outer surfaces of the bottom structure (A) 4, bottom structure (B) 16, and the inner surface of the cavity have smooth textures, thus the interference fit tolerance and compression forces provide a ensconce fit into each cavity within the post-it note assembly and paper clip holder structure (B) 20.

FIGS. 14 and 15, are dismantled versions of the full assembly which depicts the isometric and rear exploded views thereby typifies clarity, and is positioned vertically where each detailed part or assembly is identifiable. The flat rectangular outer surface of both bottom structure (A) 4 and bottom structure (B) 16 are macroscopic.

FIGS. 13, 14 and 15 represent the most efficient, convenient, stable, sturdy, aesthetically diverse, and cost conservative design for the cap structure 18 and the post-it note assembly and paper clip holder structure (B) 20, which can be manufactured from the following materials but not limited to, a rigid thermoplastic or thermoset polymer, by which plastic injection molding machine, casting dies as well as tooling equipment would be required for production.

Per post-it note assembly and paper clip holder structure (B) 20, regardless of the material, the wall structure is solid from the interior surface to exterior surface, thus providing stability for the components that will be encapsulated within the structure and surface texture.

The most massive component per FIGS. 13, 14 and 15 within the entire combination post-it note and paper clip holder 21 assembly is the post-it note assembly and paper clip holder structure (B) 20, fabricated from a polymer based material. The second most massive component is the magnet 19. Then the mass tapers down from the cap structure 18, post-it note assembly (A) 1, to post-it note assembly (B) 7, and finally the paper clip 10.

The best use of the invention is to have a fully assembled, ready for use combination post-it note and paper clip holder 21 on but not limited to a desktop, table, computer, chair, shelf, window seal, box within your office, room, school, library, coffee shop or any other location of choice. The combination post-it note and paper clip holder 21 should be within an arms distance in order to retrieve a paper clip 10 or flag from flag set (A) 3, flag set (B) 5, flag set (C) 6, flag set (D) 15 or flag set (E) 17.

An alternative way to use the inventions is to advertise companies' information and or logo by printing it on the flat outer surface of the post-it note assembly and paper clip holder 9 structure A 8 or post-it note assembly and paper clip holder structure (B) 20. If the end user is using the device outdoors then it could be used as a paper weight. Another alternative could be to store money either coins or paper currency within the interior cavity of the post-it note assembly and paper clip holder structure (B) 20.

Operation of the assembly consist of: having a completely amassed combination post-it note and paper clip holder 21 by obtaining the primary structure which would be either or both, the post-it note assembly and paper clip holder 9 structure A 8 and/or the post-it note assembly and paper clip holder structure (B) 20.

When the post-it note assembly and paper clip holder 9 structure A 8 is being used the first step is to fill the paper clip holder 9 with paper clip 10, inserting the desired quantity through the top circular hole of the paper clip holder 9 until the interior chamber is ensconced with paper clip 10, per FIGS. 6, 8 and 9.

The second step is to position/sit the base structure on a flat surface, such as a table, desk or other type of platform. Hold the post-it note assembly and paper clip holder 9 structure A 8 in place with one hand. Per FIGS. 6 and 9, insert the paper clip holder 9 by vertically aligning the exterior four corners of the paper clip holder 9 with the interior four corners that exhibit a 90 degree angle at each corner. Once the paper clip holder 9 is held with one hand and vertically aligned above the post-it note assembly and paper clip holder 9 structure A 8, begin the slow descend into the post-it note assembly and paper clip holder 9 structure A 8 chamber, by applying a force to the top perpendicular surface in the axially downward direction until the horizontal bottom surface of the paper clip holder 9 mates with the horizontal bottom surface of the post-it note assembly and paper clip holder 9 structure A 8 and contact is confirmed.

Next, encapsulate each of the post-it note assembly (A) 1 and post-it note assembly (B) 7 as desiderated, yet the top structure A 2 and top structure (B) 14 as well as bottom structure (A) 4 and bottom structure (B) 16 must be stationed to face the proper arrayed direction. Begin the installation process by holding a post-it note assembly (A) 1 and/or post-it note assembly (B) 7 with one hand and vertically aligning the two longest vertical edges axially above the post-it note assembly and paper clip holder 9 structure A 8, begin the slow descend into the post-it note assembly and paper clip holder 9 structure A 8 chamber, by applying a force to the top perpendicular edge in the axially downward direction until the horizontal bottom edge of the post-it note assembly (A) 1 and/or post-it note assembly (B) 7 mates with the horizontal bottom surface of the post-it note assembly and paper clip holder 9 structure A and contact is confirmed. To ensure that the post-it note assembly (A) 1 and/or post-it note assembly (B) 7 are encapsulated accurately the exterior face of the top structure A 2 and top structure (B) 14 are parallel and facing a circular opening 11 and/or an oval opening 13, at the same time a flag set (A) 3, flag set (B) 5, flag set (C) 6, flag set (D) 15 and flag set (E) 17 is protruding abaxially through a circular and/or an oval opening 13.

Operation of the dismantling consist of: applying a compression force to the perpendicular anterior surface of the top structure A 2 and/or top structure (B) 14, at the same time apply an axial force in the upward direction until the lower most horizontal edge of the post-it note assembly (A) 1 and/or post-it note assembly (B) 7 has cleared the perpendicular surfaces of the post-it note assembly and paper clip holder 9 structure A 8, as well as the paper clip holder 9.

To dismantle the paper clip holder 9 from the post-it note assembly and paper clip holder 9 structure A 8, clinch and stabilize the post-it note assembly and paper clip holder 9 structure A 8 with one hand. While the post-it note assembly and paper clip holder 9 structure A 8 is fixed, insert a finger into the hole located on the top plane of the paper clip holder 9 from the other hand and curl the finger into a hook like configuration, then station the tip of the finger against the inner wall of the paper clip holder 9. Begin applying a tensional force concurrently translating in the axially upward direction until the lower most horizontal surface has extended beyond the perpendicular surfaces of the post-it note assembly and paper clip holder 9 structure A 8.

When the post-it note assembly and paper clip holder structure (B) 20 is the choice for use, the first step is to fill the post-it note assembly and paper clip holder structure (B) 20 with paper clip 10, inserting the desired quantity through the top square hole until the interior chamber is ensconced with paper clip 10, per FIGS. 13 and 14.

The next step is to install the magnet 19 ensconced within the interior cavity of the cap structure 18 per FIG. 13. With the cap structure 18 held in the upright position with one hand and the magnet 19 in the other hand, begin the installation process by aligning the magnet 19 underneath the cap structure 18, whereas the cavity of the cap structure 18 is adjacent to the magnet 19. Mate the magnet 19 to the cap structure 18 by translating the magnet 19 in the axially upward direction with a compression force on the lower edge of the magnet 19, concurrently align the plural surfaces of the cap structure 18 and magnet 19. Continue to apply the compression force until the top edge of the magnet 19 is mated to the perpendicular interior surface of the cap structure 18.

Position the post-it note assembly and paper clip holder structure (B) 20 on a flat surface, such as a table, desk or other type of platform and hold it with one hand. Per FIGS. 13 and 14, insert the cap structure 18 by vertically aligning the exterior four corners of the cap structure 18 with the interior four corners that exhibit a 90 degree angle at each corner of the post-it note assembly and paper clip holder structure (B) 20. Once the cap structure 18 is held with one hand and vertically aligned above the post-it note assembly and paper clip holder structure (B) 20, begin the slow descend into the post-it note assembly and paper clip holder structure (B) 20 chamber, by applying a force to the top perpendicular surface in the axially downward direction until the horizontal bottom surface of the cap structure 18 mates with the first horizontal surface from the top of the post-it note assembly and paper clip holder structure (B) 20 and contact is confirmed.

Next, encapsulate each of the post-it note assembly (A) 1 and post-it note assembly (B) 7 as desiderated, yet the top structure A 2 and top structure (B) 14 as well as bottom structure (A) 4 and bottom structure (B) 16 must be stationed to face the proper arrayed direction. Begin the installation process by holding a post-it note assembly (A) 1 and/or post-it note assembly (B) 7 with one hand and vertically aligning the two longest vertical edges axially above the post-it note assembly and paper clip holder structure (B) 20, begin the slow descend into the post-it note assembly and paper clip holder structure (B) 20 chamber, by applying a force to the top perpendicular edge in the axially downward direction until the horizontal bottom edge of the post-it note assembly (A) 1 and/or post-it note assembly (B) 7 mates with the horizontal bottom surface of the post-it note assembly and paper clip holder structure (B) 20 and contact is confirmed. To ensure that the post-it note assembly (A) 1 and/or post-it note assembly (B) 7 are encapsulated accurately the exterior face of the top structure A 2 and top structure (B) 14 are plural and facing a circular opening 11 and/or an oval opening 13, at the same time a flag set (A) 3, flag set (B) 5, flag set (C) 6, flag set (D) 15 and flag set (E) 17 is protruding abaxially through a circular opening 11 and/or an oval opening 13.

Operation of the dismantling consist of: applying a compression force to the perpendicular anterior surface of the top structure A 2 and/or top structure (B) 14, at the same time apply an axial force in the upward direction until the lower most horizontal edge of the post-it note assembly (A) 1 and/or post-it note assembly (B) 7 has cleared the perpendicular surfaces of the post-it note assembly and paper clip holder structure (B) 20 as well as the cap structure 18.

To dismantle the cap structure 18 from the post-it note assembly and paper clip holder structure (B) 20, clinch and stabilize the post-it note assembly and paper clip holder structure (B) 20 with one hand. While the post-it note assembly and paper clip holder 9 structure A 8 is fixed insert a finger into the hole located on the top plane of the cap structure 18 from the other hand and curl the finger into a hook like configuration, then station the tip of the finger against the inner wall of the cap structure 18. Begin applying a tensional force concurrently translating in the axially upward direction until the lower most horizontal surface has extended beyond the perpendicular surfaces of the post-it note assembly and paper clip holder structure (B) 20.

The combination post-it note and paper clip holder 21 is meant to be used in an indoors or outdoors environment, for example but not limited to an indoors environment would be the office, room, shop, classroom and the outdoors environment would be a patio, coffee shop or in the park.

The combination post-it note and paper clip holder 21, whether it's the post-it not assembly and paper clip holder 9 structure A 8 or post-it note assembly and paper clip holder structure (B) 20 the following instructions applies to both designs.

The removal of any flag from a flag set (A) 3, flag set (B) 5, flag set (C) 6, flag set (D) 15 and flag set (E) 17 which is protruding abaxially through a circular opening 11 and/or an oval opening 13 is achieved by grasping the top of the flag set with one finger (thumb) and clamping the bottom of the flag set with another finger (index), then applying a slight compression force to ensure that there is no slippage. Simultaneously apply a tension force in the abaxial direction away from the combination post-it note and paper clip holder 21 until the flag is removed from the flag set (A) 3, flag set (B) 5, flag set (C) 6, flag set (D) 15 or flag set (E) 17.

The removal of a paper clip 10 from the combination post-it note and paper clip holder 21 is conducted by inserting one finger (index) into the circular hole in the top of the paper clip holder 9 or the cap structure 18. Next, curl the finger and apply a compression force against a paper clip 10, simultaneously move in the axial upward direction and as the paper clip 10 clears the perpendicular plane of the paper clip holder 9 or cap structure 18, grasp the equal and opposite side of the paper clip 10 with the opposing finger (thumb). Continue to translate axially in the upward direction with both fingers still applying a compression force until the paper clip 10 is completely extracted from the combination post-it note and paper clip holder 21.

Depending on the material of use, the frequency of use and the care or operation of use, the life expectancy of the post-it note assembly and paper clip holder 9 structure A 8 and/or post-it note assembly and paper clip holder structure (B) 20, shall vary, yet from historical data of using polymers in this configuration and capacity a minimum of 5 years is expected. The preferred material of use is a rigid polymer base that is non-permeable. The frequency of use would be an average of 30 times per day. The care or operation of use, would be moderately lifting the complete assembly off of the table, desk or other platform of stability and moving it from a particular location and placing it down with minimum compression force on the same or another table, desk or other platform.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A combination post-it note and paper clip holder for holding post-it note assemblies in the vertical position as well as holding paper clips within a containment device for convenient accessibility, space savings, organizing home, office or student area(s) at a cost effective price for the end user, comprising:
means for holding, stabilizing, aligning and packaging each post-it note assembly into the post-it note and paper clip holder. it also provides decorative color for the ambience within the user's area. lastly, but not limited to the function of portability, for example all of the post-it notes as well as the paper clip are package in a compact holder ready to be moved and/or ready for use at any time;
means for protecting and providing an opening for paper clips to be added and removed for use by the end user. also, it provides a structure for the magnet to be mated and fixated for stability. lastly, but not limited to providing a cap structure for the post-it note and paper clip holder structure;
means for magnetically attracting the metallic paper clips after the magnet has been properly mated to the cap structure. the magnet shall hold the paper clips close to the top of the cap structure so that they are easily accessible for the end user, snugly encircling to said means for protecting and providing an opening for paper clips to be added and removed for use by the end user. also, it provides a structure for the magnet to be mated and fixated for stability. lastly, but not limited to providing a cap structure for the post-it note and paper clip holder structure; and
means for holding, stabilizing, aligning and packaging each post-it note assembly into the post-it note and paper clip holder. it also provides decorative color for the ambience within the user's area. lastly, but not limited to the function of portability, for example all of the post-it notes as well as the paper clip are package in a compact holder ready to be moved and/or ready for use at any time, firmly encompassing to said means for protecting and providing an opening for paper clips to be added and removed for use by the end user. also, it provides a structure for the magnet to be mated and fixated for stability. lastly, but not limited to providing a cap structure for the post-it note and paper clip holder structure.

2. The combination post-it note and paper clip holder in accordance with claim 1, wherein said means for holding, stabilizing, aligning and packaging each post-it note assembly into the post-it note and paper clip holder. it also provides decorative color for the ambience within the user's area. lastly, but not limited to the function of portability, for example all of the post-it notes as well as the paper clip are package in a compact holder ready to be moved and/or ready for use at any time comprises a rigid non-compressible structure, plastic material, various color selections, injection molded, sharp edges and contours, smooth interior and exterior texture, light-weight, portable post-it note assembly and paper clip holder structure (a).

3. The combination post-it note and paper clip holder in accordance with claim 1, wherein said means for protecting and providing an opening for paper clips to be added and removed for use by the end user. also, it provides a structure for the magnet to be mated and fixated for stability. lastly, but not limited to providing a cap structure for the post-it note and paper clip holder structure comprises a rigid non-compressible structure, plastic material, various color selections, injection molded, sharp edges, smooth interior and exterior texture, light-weight, portable cap structure.

4. The combination post-it note and paper clip holder in accordance with claim 1, wherein said means for magnetically attracting the metallic paper clips after the magnet has been properly mated to the cap structure. the magnet shall hold the paper clips close to the top of the cap structure so that they are easily accessible for the end user comprises a rigid non-compressible, magnetic material, natural black in color, molded, sharp edges and flat on all sides, smooth exterior texture, light-weight, portable magnet.

5. The combination post-it note and paper clip holder in accordance with claim 1, wherein said means for holding, stabilizing, aligning and packaging each post-it note assembly into the post-it note and paper clip holder. it also provides decorative color for the ambience within the user's area. lastly, but not limited to the function of portability, for example all of the post-it notes as well as the paper clip are package in a compact holder ready to be moved and/or ready for use at any time comprises a rigid non-compressible structure, plastic material, various color selections, injection molded, sharp edges and contours, smooth interior and polished exterior texture, light-weight, portable post-it note assembly and paper clip holder structure (b).

6. A combination post-it note and paper clip holder for holding post-it note assemblies in the vertical position as well as holding paper clips within a containment device for convenient accessibility, space savings, organizing home, office or student area(s) at a cost effective price for the end user, comprising:
a rigid non-compressible structure, plastic material, various color selections, injection molded, sharp edges and contours, smooth interior and exterior texture, light-weight, portable post-it note assembly and paper clip holder structure (a), for holding, stabilizing, aligning and packaging each post-it note assembly into the post-it note and paper clip holder. it also provides decorative color for the ambience within the user's area. lastly, but not limited to the function of portability, for example all of the post-it notes as well as the paper clip are package in a compact holder ready to be moved and/or ready for use at any time;
a rigid non-compressible structure, plastic material, various color selections, injection molded, sharp edges, smooth interior and exterior texture, light-weight, portable cap structure, for protecting and providing an opening for paper clips to be added and removed for use by the end user. also, it provides a structure for the magnet to be mated and fixated for stability. lastly, but not limited to providing a cap structure for the post-it note and paper clip holder structure;
a rigid non-compressible, magnetic material, natural black in color, molded, sharp edges and flat on all sides, smooth exterior texture, light-weight, portable magnet, for magnetically attracting the metallic paper clips after the magnet has been properly mated to the cap structure. the magnet shall hold the paper clips close to the top of the cap structure so that they are easily accessible for the end user, snugly encircling to said cap structure; and
a rigid non-compressible structure, plastic material, various color selections, injection molded, sharp edges and contours, smooth interior and polished exterior texture, light-weight, portable post-it note assembly and paper clip holder structure (b), for holding, stabilizing, aligning and packaging each post-it note assembly into the post-it note and paper clip holder. it also provides decorative color for the ambience within the user's area. lastly, but not limited to the function of portability, for example all of the post-it notes as well as the paper clip are package in a compact holder ready to be moved and/or ready for use at any time, firmly encompassing to said cap structure.

7. The combination post-it note and paper clip holder as recited in claim 6, further comprising:
an assembly with a combination of rigid and flexible components, rectangular in shape, light-weight, portable post-it note assembly (a), for designating the entire post-it note, as an assembled group of parts and is inserted vertically into the cavity of the post-it note assembly and paper clip structure, slidingly interconnected to said post-it note assembly and paper clip holder structure (A).

8. The combination post-it note and paper clip holder as recited in claim 6, further comprising:
an assembly with a combination of rigid and flexible components, rectangular in shape, light-weight, portable post-it note assembly (b), for designating the entire post-it note, as an assembled group of parts and is inserted vertically into the cavity of the post-it note assembly and paper clip structure, symmetrically embedded to said post-it note assembly and paper clip holder structure (B).

9. The combination post-it note and paper clip holder as recited in claim 6, further comprising:
an optional configurations of post-it note types and paper clip holders, portable, rigid load bearing containment structure, light-weight when completely assembled or not combination post-it note and paper clip holder, for holding, stabilizing, aligning and packaging each post-it note assembly into the post-it note and paper clip holder. it also provides decorative color for the ambience within the user's area. lastly, but not limited to the function of portability, for example all of the post-it notes as well as the paper clip are package in a compact holder ready to be moved and/or ready for use at any time, alternately merged to said post-it note assembly and paper clip holder structure (A), and exclusively based to said post-it note assembly and paper clip holder structure (B).

10. The combination post-it note and paper clip holder as recited in claim 6, further comprising:
an assembly with only rigid components, non-compressible structure, plastic material, various color selections, injection molded, sharp edges, smooth interior and exterior texture, light-weight, portable paper clip holder, for holding and packaging paper clips within a controlled structure, while the structure is inserted into the post-it note assembly and paper clip holder structure.

11. The combination post-it note and paper clip holder as recited in claim 7, further comprising:
an assembly with a combination of rigid and flexible components, rectangular in shape, light-weight, portable post-it note assembly (b), for designating the entire post-it note, as an assembled group of parts and is inserted vertically into the cavity of the post-it note assembly and paper clip structure, symmetrically embedded to said post-it note assembly and paper clip holder structure (B).

12. The combination post-it note and paper clip holder as recited in claim 7, further comprising:
an optional configurations of post-it note types and paper clip holders, portable, rigid load bearing containment structure, light-weight when completely assembled or not combination post-it note and paper clip holder, for holding, stabilizing, aligning and packaging each post-it note assembly into the post-it note and paper clip holder. it also provides decorative color for the ambience within the user's area. lastly, but not limited to the function of portability, for example all of the post-it notes as well as the paper clip are package in a compact holder ready to be moved and/or ready for use at any time, alternately merged to said post-it note assembly and paper clip holder structure (A), and exclusively based to said post-it note assembly and paper clip holder structure (B).

13. The combination post-it note and paper clip holder as recited in claim 7, further comprising:
an assembly with only rigid components, non-compressible structure, plastic material, various color selections, injection molded, sharp edges, smooth interior and exterior texture, light-weight, portable paper clip holder, for holding and packaging paper clips within a controlled structure, while the structure is inserted into the post-it note assembly and paper clip holder structure.

14. The combination post-it note and paper clip holder as recited in claim 8, further comprising:
an optional configurations of post-it note types and paper clip holders, portable, rigid load bearing containment structure, light-weight when completely assembled or not combination post-it note and paper clip holder, for holding, stabilizing, aligning and packaging each post-it note assembly into the post-it note and paper clip holder. it also provides decorative color for the ambience within the user's area. lastly, but not limited to the function of portability, for example all of the post-it notes as well as the paper clip are package in a compact holder ready to be moved and/or ready for use at any time, alternately merged to said post-it note assembly and paper clip holder structure (A), and exclusively based to said post-it note assembly and paper clip holder structure (B).

15. The combination post-it note and paper clip holder as recited in claim 8, further comprising:
an assembly with only rigid components, non-compressible structure, plastic material, various color selections, injection molded, sharp edges, smooth interior and exterior texture, light-weight, portable paper clip holder, for holding and packaging paper clips within a controlled structure, while the structure is inserted into the post-it note assembly and paper clip holder structure.

16. The combination post-it note and paper clip holder as recited in claim 9, further comprising:
an assembly with only rigid components, non-compressible structure, plastic material, various color selections, injection molded, sharp edges, smooth interior and exterior texture, light-weight, portable paper clip holder, for holding and packaging paper clips within a controlled structure, while the structure is inserted into the post-it note assembly and paper clip holder structure.

17. The combination post-it note and paper clip holder as recited in claim 11, further comprising:
an optional configurations of post-it note types and paper clip holders, portable, rigid load bearing containment structure, light-weight when completely assembled or not combination post-it note and paper clip holder, for holding, stabilizing, aligning and packaging each post-it note assembly into the post-it note and paper clip holder. it also provides decorative color for the ambience within the user's area. lastly, but not limited to the function of portability, for example all of the post-it notes as well as the paper clip are package in a compact holder ready to be moved and/or ready for use at any time, alternately merged to said post-it note assembly and paper clip holder structure (A), and exclusively based to said post-it note assembly and paper clip holder structure (B).

18. The combination post-it note and paper clip holder as recited in claim 11, further comprising:
an assembly with only rigid components, non-compressible structure, plastic material, various color selections, injection molded, sharp edges, smooth interior and exterior texture, light-weight, portable paper clip holder, for holding and packaging paper clips within a controlled structure, while the structure is inserted into the post-it note assembly and paper clip holder structure.

19. The combination post-it note and paper clip holder as recited in claim 12, further comprising:
an assembly with only rigid components, non-compressible structure, plastic material, various color selections, injection molded, sharp edges, smooth interior and exterior texture, light-weight, portable paper clip holder, for holding and packaging paper clips within a controlled structure, while the structure is inserted into the post-it note assembly and paper clip holder structure.

20. The combination post-it note and paper clip holder as recited in claim 14, further comprising:
an assembly with only rigid components, non-compressible structure, plastic material, various color selections, injection molded, sharp edges, smooth interior and exterior texture, light-weight, portable paper clip holder, for holding and packaging paper clips within a controlled structure, while the structure is inserted into the post-it note assembly and paper clip holder structure.

21. A combination post-it note and paper clip holder for holding post-it note assemblies in the vertical position as well as holding paper clips within a containment device for convenient accessibility, space savings, organizing home, office or student area(s) at a cost effective price for the end user, comprising:
an assembly with a combination of rigid and flexible components, rectangular in shape, light-weight, portable post-it note assembly (a), for designating the entire post-it note, as an assembled group of parts and is inserted vertically into the cavity of the post-it note assembly and paper clip structure;
a rigid structure, housing, plastic material, transparent, molded top structure a, for protecting the flags from debris and provides a rigid transparent structural housing;
an assembly with a combination of rigid and flexible components, rectangular in shape, light-weight, portable post-it note assembly (b), for designating the entire post-it note, as an assembled group of parts and is inserted vertically into the cavity of the post-it note assembly and paper clip structure;
a rigid non-compressible structure, plastic material, various color selections, injection molded, sharp edges and contours, smooth interior and exterior texture, light-weight, portable post-it note assembly and paper clip holder structure (a), for holding, stabilizing, aligning and packaging each post-it note assembly into the post-it note and paper clip holder. it also provides decorative color for the ambience within the user's area. lastly, but not limited to the function of portability, for example all of the post-it notes as well as the paper clip are package in a compact holder ready to be moved and/or ready for use at any time, slidingly interconnected to said post-it note assembly (A);
a rigid non-compressible structure, plastic material, various color selections, injection molded, sharp edges, smooth interior and exterior texture, light-weight, portable cap structure, for protecting and providing an opening for paper clips to be added and removed for use by the end user. also, it provides a structure for the magnet to be mated and fixated for stability. lastly, but not limited to providing a cap structure for the post-it note and paper clip holder structure;
a rigid non-compressible, magnetic material, natural black in color, molded, sharp edges and flat on all sides, smooth exterior texture, light-weight, portable magnet, for magnetically attracting the metallic paper clips after the magnet has been properly mated to the cap structure. the magnet shall hold the paper clips close to the top of the cap structure so that they are easily accessible for the end user, snugly encircling to said cap structure;
a rigid non-compressible structure, plastic material, various color selections, injection molded, sharp edges and contours, smooth interior and polished exterior texture, light-weight, portable post-it note assembly and paper clip holder structure (b), for holding, stabilizing, aligning and packaging each post-it note assembly into the post-it note and paper clip holder. it also provides decorative color for the ambience within the user's area. lastly, but not limited to the function of portability, for example all of the post-it notes as well as the paper clip are package in a compact holder ready to be moved and/or ready for use at any time, firmly encompassing to said cap structure, and symmetrically embedded to said post-it note assembly (B);
an optional configurations of post-it note types and paper clip holders, portable, rigid load bearing containment structure, light-weight when completely assembled or not combination post-it note and paper clip holder, for holding, stabilizing, aligning and packaging each post-it note assembly into the post-it note and paper clip holder. it also provides decorative color for the ambience within the user's area. lastly, but not limited to the function of portability, for example all of the post-it notes as well as the paper clip are package in a compact holder ready to be moved and/or ready for use at any time, exclusively based to said post-it note assembly and paper clip holder structure (B), and alternately merged to said post-it note assembly and paper clip holder structure (A); and
an assembly with only rigid components, non-compressible structure, plastic material, various color selections, injection molded, sharp edges, smooth interior and exterior texture, light-weight, portable paper clip holder, for holding and packaging paper clips within a controlled structure, while the structure is inserted into the post-it note assembly and paper clip holder structure.
